(19) United States
(12) Patent Application Publication
(10) Pub. No.: US 2011/0197914 A1
(43) Pub. Date: Aug. 18, 2011

(54) TOOTHPICK

(76) Inventor: Jeung Joon Choi, Seoul (KR)

(21) Appl. No.: 12/865,389

(22) PCT Filed: Jan. 24, 2009
(86) PCT No.: PCT/KR2009/000389

§ 371 Date: Nov. 24, 2010

(30) Foreign Application Priority Data
Jan. 29, 2008 (KR) 20-2008-0001309

(51) Int. Cl. A61C 15/02

(52) U.S. Cl. 132/329

(57) ABSTRACT

Disclosed is a toothpick having a structure wherein the two ends each have different functions. The toothpick comprises two end portions with one end portion configured in a linear body and the other end portion configured in a hook body, wherein the tips of both end portions are pointed, the overall cross section is elliptical and the overall surface is embossed. The linear body can be used for relatively easy removal of food waste retained in the mouth, while the hook body is used to efficiently remove food stuck deep in the mouth. The embossed surface of the toothpick helps to improve the removal of food waste.

### TECHNICAL FIELD

The present invention relates to a toothpick that removes food waste stuck in the gaps between teeth and protects the gums, in more detail, a toothpick basically having both end portions having substantially the same thin structure as the gaps between teeth such that the ends can be freely inserted between the gaps between the teeth to easily remove food waste. In particular, both end portions of the toothpick are configured in a linear body and a hook body, such that the linear body is generally used to easily remove waste food n the front of the teeth and the hook body is used to remove food waste stuck deep in the rear portion or in the back teeth in the mouth while complementing each other. Further, the toothpick has improved function of removing food waste by embossing the surfaces of the end portions to easily remove food waste with the surface of the end portions.

### BACKGROUND ART

Toothpicks commonly used in the related art is made of wood or starch, of which the tips are formed in a cylindrical or rectangular rod shape which is pointed and sharp; however, the shapes are contrary to the substantial structure of the gaps of teeth, such that there are problems and limits in that they are not effective in inserting between the teeth and removing food waste. Further, the gums are likely to be hurt due to wrong use and the gaps between the teeth become large while holes are formed and tartar sticks on the teeth when the toothpicks are used for a long period of time.

When the food waste stuck deep inside the mouth or the backteeth is not completely removed and left, bacteria as well as tartar develop, which causes foul breath and hurts the gums.

Dental floss steamdate and interdental blush are commonly used as toothpicks at the present time; however, they are not widely used, such that this may be another reason for requiring a new and effective toothpick.

It is considerably required to develop a toothpick that can remove the problems and effectively clean the mouth; however, there is no toothpick yet which is developed in a reasonable structure and commercialized to wide use. Therefore, this generation has responsibility of improving the toothpicks that is a necessary for the food culture in the basic dietary life of the human being even at a level ranking next to the considerably developed science and civilized life.

Accordingly, the present invention has been made to provide a structure, considering the situations and the conditions. The present invention provides a toothpick is formed of a thin and elastic injection-molded plastic to be inserted in a narrow space between teeth. Therefore, it is possible to improve the function of the toothpick by forming a linear body and a hook body to remove food waste, without hurting the gums, and complement each other.

Further, the present invention significantly improves the function of removal of food waste by rounding both end portions of the toothpick and embossing the surfaces.

### DISCLOSURE

Since most toothpicks generally used at the present time have the ends formed in cylindrical or rectangular rod shapes which are thin and pointed, it is difficult to insert the ends between teeth and it takes long time to remove food waste even if the ends are inserted. Most people currently use those toothpicks.

The present invention provide a toothpick having a structure of which both ends are thin and the width has the same structure as the longitudinal structure of the gaps between teeth, in which the ends are freely inserted into the gaps of the teeth to easily remove food waste and the surfaces of the ends are embossed to easily remove the food waste, thereby improving the effect.

The present invention makes it possible to clean the mouth quickly by removing the remaining food waste by using a hook body, when it is difficult to completely remove the food waste with a linear body.

### DESCRIPTION OF DRAWINGS

1. Toothpick
2. Body
3. Linear body
4. Hook body
5. Embossing
6. Body embossing

FIG. 1 is a perspective view of a toothpick according to the present invention.

FIG. 2 is a cross-sectional view of both end structures of the present invention, taken along the line A-A.

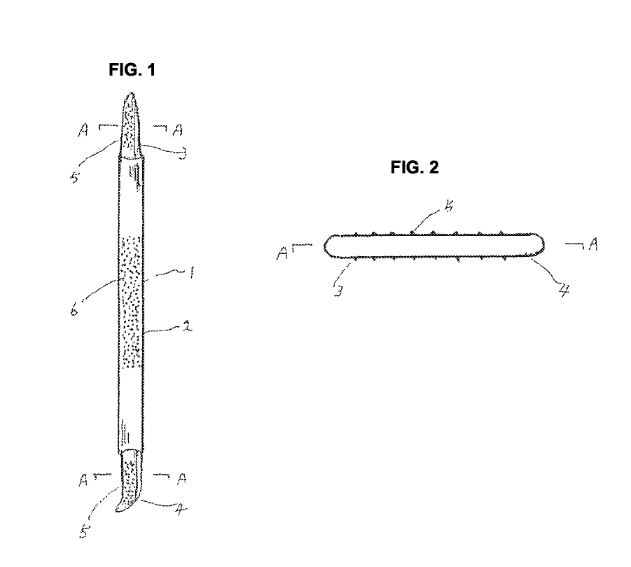

### BEST MODE

The present invention can be very easily achieved and industrialized.

A toothpick according to the present invention can be easily manufactured as a product and commercialized by injection-molding plastic, which is an organic compound.

The toothpick having both end portions configured in a linear body and a hook body is injection-molded by a mold manufactured in a desired shape, as a plastic product that is a popular one of the current daily necessities. Therefore, it is easy to achieve and commercialize the present invention as a product, thereby contributing to the present society in various ways.

### INDUSTRIAL APPLICABILITY

The toothpick of the present invention is made of plastic organic compound by injection-molding with a predetermined mold, such that it is possible to mass-produce the toothpick and provide the toothpick as an inexpensive product to the market.

Since the toothpick is made of an injection-molded plastic, which is the most widely used in the current industry, it can be easily manufactured and provided as a product.

Since the toothpick is made of plastic that has elasticity and does not hurt the gums, it is not dispensable, but can be repeatedly used. Further, it is possible to use the toothpick always in a sanitized state by putting the toothpick in a case filled with mouth sanitary water.

1. A toothpick, wherein one end portion of a body is configured in a linear body 3 having a flat elliptic shape having an embossed surface 5, the other end of the body 2 is configured in a hook body 4 having a flat elliptic shape having an embossed surface 5, the tips of the end portions are rounded, and the body 2 has a embossed surface 6.
